(19) United States
(12) Patent Application Publication
(10) Pub. No.: US 2006/0181495 A1
(43) Pub. Date: Aug. 17, 2006

(54) Active matrix array device

(76) Inventor: Martin J. Edward, Crawley (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/564,237

(22) PCT Filed: Jul. 7, 2004
(86) PCT No.: PCT/IB04/02273

§ 371 Date: Jan. 10, 2006

(30) Foreign Application Priority Data
Jul. 15, 2003 (GB) 0316482.9

(51) Int. Cl. G09G 3/36

(52) U.S. Cl. 345/92

(57) ABSTRACT

An active matrix array (25), e.g. an active matrix liquid crystal display array, comprising an array of matrix elements (10), e.g. pixels (10), each comprising a circuit, e.g. a refresh circuit comprising a CMOS inverter (70); and column conductors (16) arranged for inputting data signals (117) to, or outputting data signals from, the matrix elements (10) of a respective column in first time periods (140). Power supply voltages (V1, V2) for the circuit are supplied via the same column conductors (10) in second time periods (130) interspersed between the first periods (140). The matrix elements (10) operate differently according to whether the column conductors (16) are being supplied with the power supply voltages (V1, V2) or the data signals (117). Thus data signal column conductors (16) are used to apply the power supply voltages (V1, V2) as well as the data signals (117).

The present invention relates to active matrix array devices comprising arrays of matrix elements, and to driving or addressing methods for such active matrix array devices. The present invention relates particularly, but not exclusively, to active matrix array devices in which the matrix elements comprise display pixels, especially active matrix liquid crystal display devices and active matrix electroluminescent display devices.

Active matrix array devices comprising arrays of matrix elements, and driving or addressing methods for such active matrix array devices, are well known. One type of example is an active matrix display device, for example an active matrix liquid crystal display device where each matrix element includes a pixel and a switching transistor. Another type of example is an active matrix sensor array used, for example in a two dimensional light sensing or imaging device.

As performance requirements for active matrix array devices increase, more complicated circuitry (other than, say, simple switching and latching circuitry) has been incorporated within each matrix element, e.g. each pixel circuit. Some of these circuits require conventional power supply voltages, e.g. two separate d.c. voltages, often referred to as VSS and VDD, to be supplied to them. Examples of such circuits are refresh circuits as disclosed in WO 03/007286, where the refresh circuits include a CMOS inverter and operate to periodically invert and restore a voltage level on a pixel display electrode.

Conventionally, the power supply voltages to these in-element circuits are provided using dedicated horizontal and/or vertical conductors, provided in addition to row and column conductors provided for the main operation of the active matrix array. This requires additional manufacturing processes. Also, this leads to reduced availability of processing area for the conventional parts of each array element. Also, this may lead to reduced performance, e.g. in a display device the aperture of a pixel may be reduced by the provision of dedicated horizontal and/or vertical conductors for applying the power supply voltages.

The present inventors have realised it would be advantageous to provide power supply voltages to circuits within matrix array elements by using the same column conductors that are used for supplying data to the array elements (in the case of an array device where the main function of the array element requires receipt of data, such as picture data in the case of a display array) or extracting or outputting data from matrix array elements (in the case of an array device where the main function of the array element requires extraction or output of data, such as sensor data in the case of a sensor array).

In a first aspect, the present invention provides an active matrix array, comprising an array of matrix elements arranged in rows and columns, each matrix element comprising a circuit; a plurality of column conductors, each arranged for inputting data signals to, or outputting data signals from, the matrix elements of a respective column in first time periods; and means for providing power supply voltages for the circuit to the matrix element via the column conductors in second time periods interspersed or alternated between the first time periods.

Preferably each matrix element comprises differentiating means for operating differently according to whether the column conductors are being supplied with the power supply voltages or whether the column conductors are being supplied with the data signals.

Preferably the array further comprises means for receiving a control signal to the matrix elements, the control signal being such as to indicate to the matrix elements when the column conductors are being supplied with the power supply voltages and when the column conductors are being supplied with the data signals; and wherein the differentiating means in each matrix element comprise means for operating differently in response to the control signal.

The array may be a display array, with the matrix elements being pixels. Each pixel may comprise, in addition to a respective one of the circuits, a pixel electrode and a pixel select switching means, such as a transistor, coupled to the pixel electrode.

The circuit may be a refresh circuit for refreshing the pixel electrode.

The pixels may be adapted such that the control signal is used to indicate to the pixel when the column conductors are carrying the power supply voltages and to switch the pixel from a state where the pixel electrode receives picture data from the column electrodes to a state where the pixel electrode receives inverted refresh picture data from the refresh circuit.

In any of the above variations, the circuit may comprise a CMOS inverter or other CMOS, NMOS or PMOS circuitry requiring a VSS power supply voltage and a VDD power supply voltage.

In one preferred embodiment, the means for receiving a control signal is coupled to the gate of a “first” TFT, the “first” TFT being arranged to allow picture data to be provided to the pixel electrode only when the control signal is set such as to turn the “first” TFT on. Preferably, the means for receiving a control signal is coupled to the gate of a “second” TFT, the “second” TFT being arranged to allow refresh data to be provided from the refresh circuit to the pixel electrode only when the control signal is set such as to turn the “second” TFT on and the “first” TFT off. Also preferably the means for receiving a control signal is coupled to the gate of a “third” TFT, the “third” TFT being arranged to allow the power supply voltages to be supplied to the refresh circuit only when the control signal is set such as to turn the “second” and “third” TFTs on and the “first” TFT off.

In any of the above variations, a first power supply voltage level is supplied to the circuits of a first column of matrix elements via a first column conductor arranged to also input or output data signals to or from the first column of matrix elements, and a second power supply voltage level is supplied to the circuits of the first column of matrix elements via a second column conductor arranged to also input or output data signals to or from a second column of matrix elements.

In a further aspect, the present invention provides a method of operating an active matrix array device comprising an array of matrix elements arranged in rows and columns, wherein each matrix element comprises a circuit requiring power supply voltages to be supplied to the circuit, the method comprising: in first time periods, inputting a data signal to, or outputting a data signal from, the matrix element via column conductors; and in second time periods interspersed or alternated with the first time periods, providing the power supply voltages to the circuit via the column conductors.

Preferred forms of the method provided by this invention include variations of this method achieved and/or performed by using any or all of the features mentioned above as variations and preferred forms of the active matrix array provided by the first aspect of this invention.

In a further aspect, the present invention provides an active matrix array, e.g. an active matrix liquid crystal display array, comprising an array of matrix elements, e.g. pixels, the matrix elements comprising respective circuits, e.g. a refresh circuit comprising a CMOS inverter; and column conductors arranged for inputting data signals to the matrix elements of a respective column in first time periods (or arranged for outputting data signals from the matrix elements of a respective column in first time periods). Power supply voltages (V1, V2) for the circuit are supplied via the same column conductors in second time periods interspersed between the first periods. The matrix elements are adapted such as to operate differently according to whether the column conductors are being supplied with the power supply voltages (V1, V2) or the data signals. The data signal column conductors are used to apply the power supply voltages (V1, V2) as well as apply or output the data signals.

Embodiments of the present invention will now be described, by way of example, with reference to the accompanying drawings, in which:

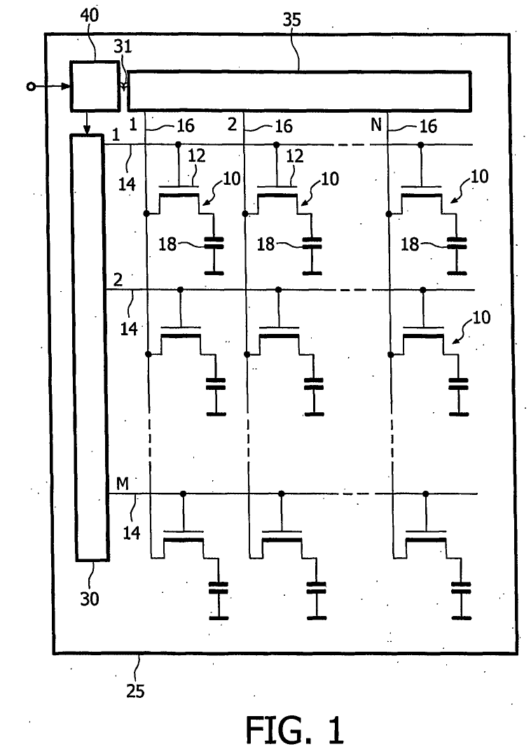

FIG. 1 is a schematic diagram of an active matrix liquid crystal display device in which a first embodiment of the invention is implemented;

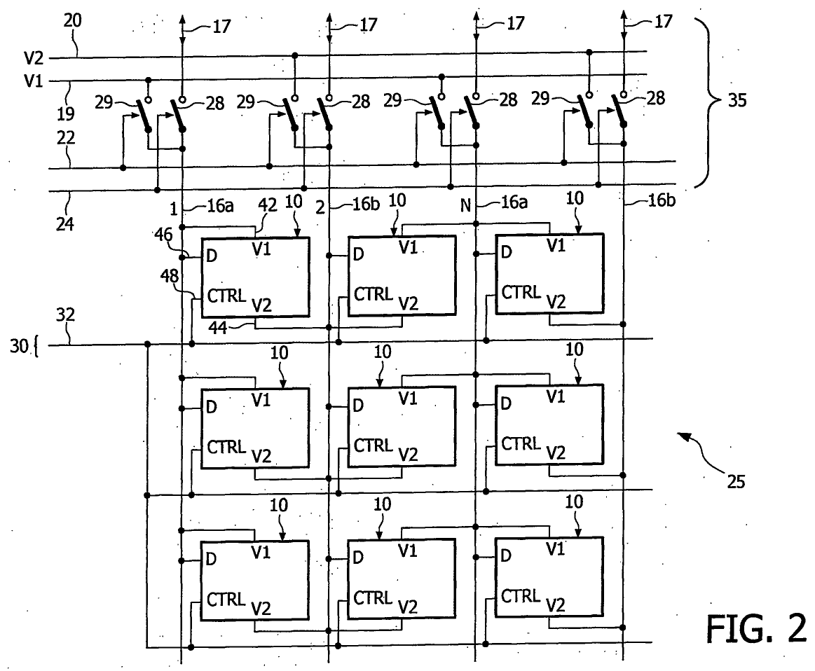

FIG. 2 is a schematic diagram of a liquid crystal panel of the display device of FIG. 1;

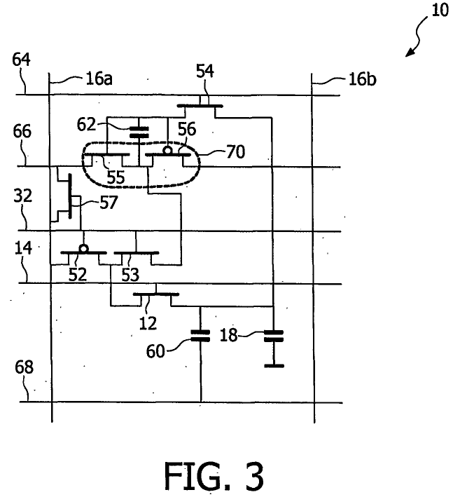

FIG. 3 is a circuit diagram of a pixel of the liquid crystal panel of FIG. 2;

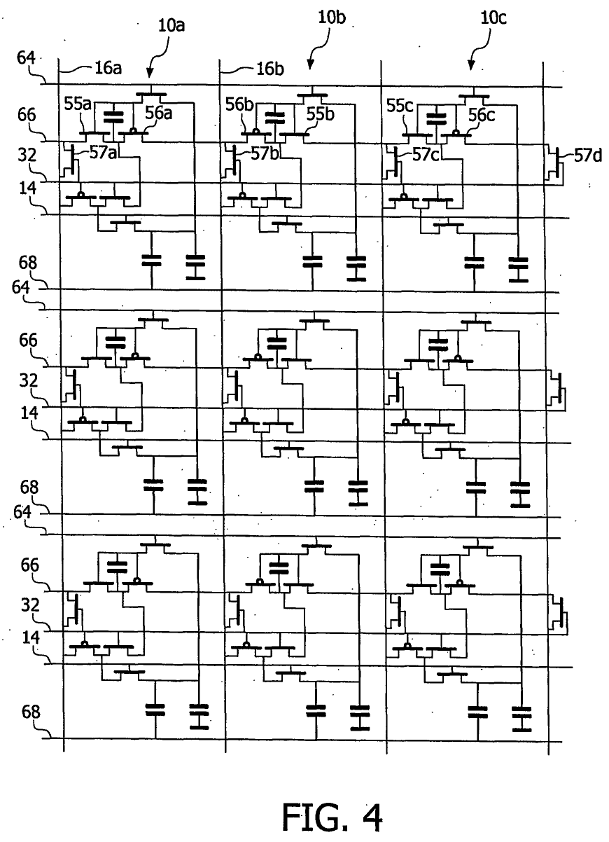

FIG. 4 is a circuit diagram showing the circuit diagram detail of FIG. 3 for an array of three by three pixels;

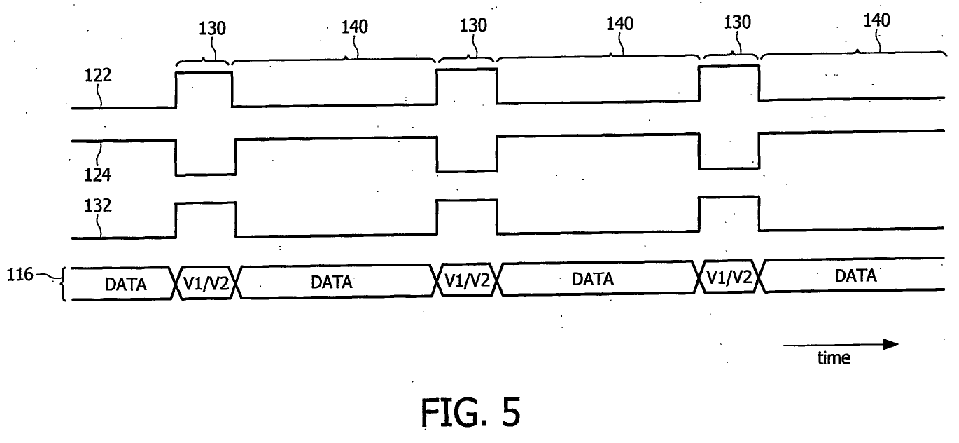

FIG. 5 illustrates qualitatively various waveforms and signals applied in the operation of the liquid crystal panel of FIG. 2;

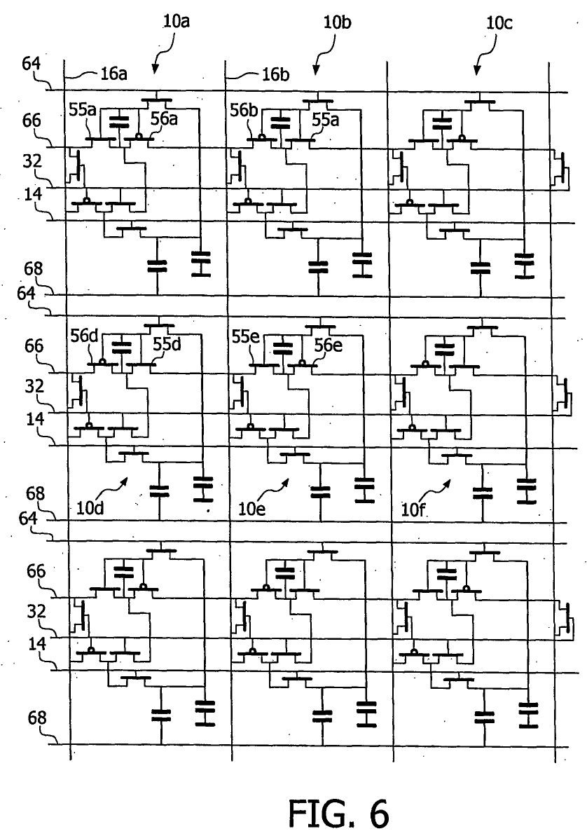

FIG. 6 is a circuit diagram showing a three by three portion of a pixel array; and

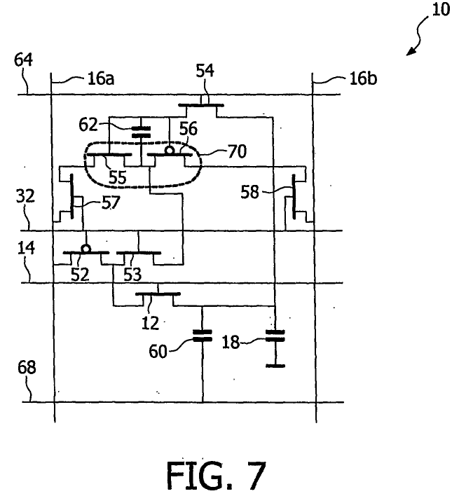

FIG. 7 is a circuit diagram of a pixel comprising two isolation TFTs.

FIG. 1 is a schematic diagram of an active matrix liquid crystal display device in which a first embodiment of the invention is implemented. The display device, which is suitable for displaying video pictures, comprises an active matrix addressed liquid crystal display panel 25 having a row and column array of pixels which consists of M rows (1 to M) with N horizontally arranged pixels 10 (1 to N) in each row. Only a few of the pixels are shown for simplicity.

Each pixel 10 is associated with a respective switching device in the form of a thin film transistor, TFT, 12. The gate terminals of all TFTs 12 associated with pixels in the same row are connected to a common row conductor 14 to which, in operation, selection (gating) signals are supplied. Likewise, the source terminals associated with all pixels in the same column are connected (via respective further transistors which will be explained below, and which are not shown in FIG. 1) to a common column conductor 16 to which data (video) signals are applied. The drain terminals of the TFTs are each connected to a respective transparent pixel electrode 18 forming part of, and defining, the pixel. The conductors 14 and 16, TFTs 12 and electrodes 18 are carried on one transparent plate while a second, spaced, transparent plate carries an electrode common to all the pixels, usually referred to as the common electrode. Liquid crystal is disposed between the plates.

The display panel is operated in conventional manner. Light from a light source disposed on one side enters the panel and is modulated according to the transmission characteristics of the pixels 10. The device is driven one row at a time by scanning the row conductors 14 sequentially with a selection (gating) signal so as to turn on each row of TFTs in turn and applying data (video) signals to the column conductors for each row of picture display elements in turn as appropriate and in synchronism with the selection signals so as to build up a complete display frame (picture). Using one row at time addressing, all TFTs 12 of the selected row are switched on for a period determined by the duration of the selection signal corresponding to a video signal line time during which the video information signals are transferred from the column conductors 16 to the pixel electrodes 18. Also, as will be explained in more detail below, refresh signals are transferred to the pixel electrodes 18.

Upon termination of the selection signal, the TFTs 12 of the row are turned off for the remainder of the frame period, thereby isolating the pixels from the conductors 16 and ensuring the applied charge is stored on the pixels until the next time they are addressed in the next frame period. (In view of the above described function of the TFTs 12, and in order to readily distinguish them from other TFTs to be described later below, these TFTs 12 are hereinafter referred to as pixel select TFTs 12.)

The row conductors 14 are supplied successively with selection signals by a row driver circuit 30 comprising a digital shift register controlled by regular timing pulses from a timing and control unit 40. In the intervals between selection signals, the row conductors 14 are supplied with a substantially constant reference potential by the row driver circuit 30. Video information signals are supplied to the column conductors 16 from a column driver circuit 35, here shown in basic form, comprising one or more shift register/sample and hold circuits. The column driver circuit 35 is supplied over a bus 31 with video signals from a video processing circuit in the timing and control unit 40. The column driver circuit 35 is also supplied over the bus 31 with timing pulses from a timing circuit in the timing and control unit 40. The video signals and timing pulses are supplied in synchronism with row scanning to provide serial to parallel conversion appropriate to the row at a time addressing of the panel 25.

Other details of the liquid crystal display device, except where otherwise stated below in relation to refreshing the pixels, and in particular, the provision of power supply voltages to refresh circuitry (not shown in FIG. 1) in the pixels, may be as per any conventional active matrix liquid crystal display device. In this particular embodiment such other details are the same as, and operate the same as, the liquid crystal display device disclosed in U.S. Pat. No. 5,130,829, the contents of which are contained herein by reference.

FIG. 2 is a further schematic diagram of the liquid crystal panel 25, showing in overview aspects relating to the provision of power supply voltages to refresh circuitry in the pixels 10, but for clarity omitting the row driver circuit 30 and row conductors 14 shown in FIG. 1. Items already shown in FIG. 1 are indicated with the same reference numerals.

The column driver circuit 35 comprises a respective input/output 17 for each column conductor 16 (here labelled alternately 16a and 16b) for applying conventional picture data signals to and receiving conventional signals from the corresponding column conductor 16. The column driver circuit 35 also comprises a respective picture data switch 28 for each column conductor 16. Each input/output 17 is connected to its corresponding column conductor 16 via its corresponding picture data switch 28. The column driver circuit 35 also comprises a picture data switch control line 24 connected to each picture data switch 28 for controlling operation of the picture data switches 28.

The column driver circuit 35 also comprises a first power supply voltage output 19 for supplying a first power supply voltage V1 to a first alternate set of column conductors 16, i.e. those labelled 16a, and a second power supply voltage output 20 for supplying a second power supply voltage V2 to the remaining second alternate set of column conductors 16, i.e. those labelled 16b. The column driver circuit 35 also comprises a respective power supply switch 29 for each column conductor 16. The first power supply voltage output 19 is connected to each column conductor 16a of the first alternating set via a respective power supply switch 29; likewise the second power supply voltage output 20 is connected to each column conductor 16b of the second alternating set via a respective power supply switch 29. The column driver circuit 35 also comprises a power supply switch control line 22 connected to each power supply switch 29 for controlling operation of the power supply switches 29. (In other embodiments, any of the various items described in this paragraph as being provided within the column driver circuit 35 may be provided by circuitry separate from the column driver circuit 35.)

The row driver circuit 30 comprises, in addition to conventional row select circuitry, a pixel control line 32 connected to each of the pixels 10 for supplying a pixel control signal to each of the pixels 10 (in other embodiments the pixel control line may be provided by circuitry separate from the row driver circuit 30).

In FIG. 2, each pixel 10 is represented in block diagram form. The operation of a pixel 10 will be explained in more detail below with reference to FIGS. 3 and 4. However, for the purpose of this overview, each pixel 10 may be considered to be provided with three separate inputs connected to the column conductors 16, namely a first power supply voltage input 42, a second power supply voltage input 44, and a picture data input 46. The first power supply voltage input 42 and the picture data input 46 are connected to the corresponding column conductor 16a of the first alternate set of column conductors 16. The second power supply voltage input 44 is connected to the corresponding column conductor 16b of the second alternate set of column conductors 16. Also, each pixel 10 may be considered to be provided with a separate input, namely a pixel control input 48, connected to the pixel control line 32.

In operation, signals provided to the picture data switch control line 24 and the power supply switch control line 22 are used to control whether, at a given time, picture data or power supply voltage is applied to the column conductors 16.

When picture data is being applied, i.e. when the picture data switches 28 are powered to the closed position, a given column conductor 16 provides the picture data to each of the pixels 10 in its column of pixels, i.e. when picture data is applied to the Nth column conductor 16, the picture data is provided to each of the pixels 16 in the Nth column of pixels 16.

When power supply voltage is being applied, i.e. when the power supply switches 29 are powered to the closed position, a given column conductor 16 provides one of either the first power supply voltage V1 or the second power supply voltage V2 to each of the pixels 10 in its column of pixels, and to each of the pixels in the preceding column of pixels 16 (except for the end columns where redundancy occurs). In other words, when power supply voltage is being applied, each pixel 10 receives, at its first input 42, the first power supply voltage V1 from a column conductor 16a of the first set of column conductors, and, at its separate second input 44, the second power supply voltage V2 from a column conductor 16b of the second set of column conductors.

Also, in operation, pixel control signals supplied via the pixel control line 32 are received by the pixel 10 and used to determine whether the pixel is to operate in a picture data receiving mode or a power supply voltage receiving mode, as will be explained in more detail below.

FIG. 3 is a circuit diagram of a pixel 10. As described with reference to FIGS. 1 and 2 (and where applicable using like reference numerals), the pixel comprises a pixel electrode 18 and a pixel select TFT 12. The gate of the pixel select TFT 12 is connected to the row conductor 14. The drain of the pixel select TFT 12 is connected to the pixel electrode 18. The source of the pixel select TFT 12 is connected (indirectly) to column conductor 16a. By way of further detail, a first storage capacitor 60 is shown between the drain of the pixel select TFT 12 and a storage capacitor line 68.

In operation, the pixel select TFT 12 operates as in a conventional display, whereby the gate of the pixel select TFT 12 is turned on when the row conductor 14 is supplied with a row select signal, thereby allowing a picture data signal supplied by the column conductor 16a to be fed via the source and drain of the pixel select TFT 12 to the pixel electrode 18.

The pixel 10 further comprises a p-type TFT 52 and an n-type TFT 53 (generally, TFTs not specifically described herein as n- or p-type are n-type). The source of the p-type TFT 52 is connected to the column conductor 16a. The drain of the p-type TFT 52 is connected to the drain of the TFT 53. The source of the TFT 53 is connected to refresh circuitry that will be described later below. The gates of both the p-type TFT 52 and the TFT 53 are connected to the pixel control line 32.

In operation, the p-type TFT 52 and the TFT 53 work together to effectively control the source of information supplied to the pixel electrode. Firstly, when the pixel control line is driven low this switches the p-type TFT 52 on and switches the TFT 53 off, hence the picture data supplied via from the column 16a conductor to the source of the p-type TFT 52 is fed via the drain of the p-type TFT 52 to the pixel select TFT 12 and hence to the pixel electrode 18, as described above. (Note, therefore the connection from the source of the p-type TFT 52 to the column conductor 16a forms, or effectively corresponds to, the picture data input 46 described earlier with reference to FIG. 2.)

Secondly, however, when the pixel control line is driven high, this switches the TFT 53 on and switches the p-type TFT 52 off, hence the pixel select TFT 12 and consequently the pixel electrode 18 are now fed from the refresh circuitry.

The pixel 10 further comprises two further n-type TFTs, namely TFT 54 and TFT 55, a p-type TFT 56, and a second storage capacitor 62, which together provide the refresh circuitry mentioned above. This refresh circuitry operates in corresponding fashion to the various refresh circuits described in WO 03/007286, the contents of which are incorporated herein by reference.

Related to the refresh circuitry, the liquid crystal display panel 25 comprises further lines connected to the row driver circuit, namely sample lines 64. One sample line 64 is provided along each row of pixels 12, as shown in FIG. 3. The gate of TFT 54 is connected to the sample line 64. A first source/drain terminal of the TFT 54 is connected to the pixel electrode 18. The second source/drain terminal of the TFT 54 is connected to one side of the second storage capacitor 62, and to the gates of both the TFT 55 and the p-type TFT 56. A first source/drain terminal of the TFT 55, a first source/drain terminal of the p-type TFT 56, and the other side of the second storage capacitor are connected to each other. These respective first source/drain terminals of the TFT 55 and the p-type TFT 56 each act as drains.

The second source/drain terminal of the TFT 55 and the second source/drain terminal of the p-type TFT 56 each act as sources. For clarity, description of the connections to these respective sources will be made later below. Presently it suffices to note that these connections participate in the provision, via the column conductors 16a and 16b, of the power supply voltages V1 and V2 to the refresh circuitry.

More particularly, the TFT 55 and the p-type TFT 56 in combination form a CMOS inverter 70. Also, the connection between the circuit point represented by the “gate of the TFT 55/gate of the TFT 56/the first side of the second storage capacitor” is an input of this CMOS inverter circuit 70. Furthermore, the connection between the circuit point represented by the “drain of the TFT 55/drain of the p-type TFT 56/the other side of the second storage capacitor” is an output of this CMOS inverter circuit 70. As such, the power supply voltages V1 and V2 are the power supply voltages for the CMOS inverter circuit 70, and the respective connections to the source of the TFT 55 and the source of the p-type TFT 56 are the two power supply voltage inputs of this CMOS inverter circuit 70, i.e. here VI applied to column conductor 16a is VSS and V2 applied to column conductor 16b is VDD.

The sample line 64 and the refresh circuitry (including the CMOS inverter circuit 70) serve to provide an inverted refresh signal to the pixel electrode in the fashion described in detail in WO 03/007286. In overview, this functions as follows.

It is assumed that a common electrode drive scheme is used in which part of the drive voltage required by the liquid crystal is applied to the common electrode of the display (i.e. the electrode disposed on the second spaced plate as mentioned in the description relating to FIG. 1). The common electrode is driven to one of two voltage levels depending on the polarity of the drive voltage being applied to the liquid crystal pixel. Using this drive scheme the pixel can be set to a light state or to a dark state by charging the pixel to one of two data voltage levels. Initially these voltages would be supplied from the column drive circuit via the column conductor but following this the pixel can be periodically refreshed and the voltage applied to the liquid crystal pixel inverted without transferring data from the column drive circuit. This is achieved by using the refresh circuits within the pixels as follows. The voltage on the common electrode is first returned to the value when the pixel was last addressed or refreshed. The sample line 64 is then taken to a high voltage level which turns on TFT 54 and transfers the pixel voltage to the input of the CMOS inverter 70 formed by TFT 55 and TFT 56. The two power supply voltages of the CMOS inverter are chosen to be equal to the two data voltage levels. The voltage at the input of the inverter will be close to one of the two power supply voltages of the inverter. The voltage at the output of the inverter will become the inverse of the input voltage. If the input voltage is close to VDD then the output voltage will be VSS whereas if the input voltage is close to VSS then the output voltage will be VDD. The second storage capacitor becomes charged to a voltage which is equal to the difference between the input and output voltages of the inverter. The sample line is then taken to a low voltage and TFT 54 turns off. The pixel data is now temporarily stored on the second storage capacitor 62 and the voltage at the output of the CMOS inverter represents the inverted pixel data which must be transferred back to the pixel electrode. In order to invert the drive voltage applied to the liquid crystal the common electrode of the display is now switched to the second drive voltage level and the pixel electrode is then connected to the output of the CMOS inverter via the transistors TFT 53 and TFT 12. When the pixel has charged to the voltage level at the output of the inverter it is isolated from the inverter once again by turning off TFT 12.

The pixel 10 further comprises a further TFT 57. Also, a further conduction line 66, here called a pixel interconnect line 66, is provided along each row of pixels. The pixel interconnect line 66 connects the respective sources of TFT 55 and p-type TFT 56 to sources of TFT's 55 and p-type TFT's 56 of adjoining pixels, as will be described in more detail below with reference to FIG. 4.

The source of the TFT 57 is connected to the source of the TFT 55 at the pixel interconnect line 66. The drain of the TFT 57 is connected to the column conductor 16a. The gate of the TFT 57 is connected to the pixel control line 32. (Note, as described earlier, the gates of the p-type TFT 52 and the TFT 53 are also connected to the pixel control line, and hence the common connection comprising the gate of the p-type TFT 52, the gate of the TFT 53 and the gate of the TFT 57 forms, or effectively corresponds to, the pixel control input 48 described earlier with reference to FIG. 2. Similarly, the connection between the drain of the TFT 57 and the column conductor 16a forms, or effectively corresponds to, the first power supply voltage input 42 described earlier with reference to FIG. 2.) The TFT 57 serves to isolate the earlier described connection to the source of the TFT 55 (i.e. one of the two power supply voltage inputs of the CMOS inverter circuit 70) when the column conductor 16a is being used to provide picture data input to the pixel 10, but to conduct the supply voltage to the earlier described connection to the source of the TFT 55 (i.e. one of the two power supply voltage inputs of the CMOS inverter circuit 70) when the column conductor 16a is being used to provide the power supply voltage V1. This is achieved by switching the gate of the TFT 57 using a control signal applied to the pixel control line 32 (as will be explained in more detail below).

In order to explain how the earlier described connection to the drain of the TFT 56 (i.e. the other of the two power supply voltage inputs of the CMOS inverter circuit 70) is isolated when the column conductor 16b is being used to provide picture data input to the pixel 10, reference will now be made to FIG. 4. FIG. 4 is a circuit diagram showing the circuit diagram detail of FIG. 3 for the array of three by three pixels originally shown in overview in FIGS. 1 and 2. Where convenient certain items have been identified with the same reference numerals as in the earlier Figures, however due to the large amount of detail, for clarity the majority of the components explained with reference to FIG. 3 have not been identified by reference numerals as such although they can be clearly understood as they are drawn in the same form.

A corresponding TFT 57 is provided in each pixel along a row of pixels. For convenience, in FIG. 4, the three pixels in the top row are identified as pixels 10a, 10b and 10c respectively. Furthermore, the TFT 57 of pixel 10a is identified as TFT 57a, the TFT 57 of pixel 10b is identified as TFT 57b, and the TFT 57 of pixel 10c is identified as TFT 57c. Also, the TFT 55 of pixel 10a is identified as TFT 55a, the p-type TFT 56 of pixel 10a is identified as p-type TFT 56a, the TFT 55 of pixel 10b is identified as TFT 55b, the p-type TFT 56 of pixel 10b is identified as p-type TFT 56b, the TFT 55 of pixel 10c is identified as TFT 55c, and the p-type TFT 56 of pixel 10c is identified as p-type TFT 56c.

In adjoining pixels, the TFT 55 and the p-type TFT 56 are transposed i.e. in pixel 10a the TFT 55a is to the left of the p-type TFT 56a as shown in the circuit diagram form of FIGS. 3 and 4, whereas in pixel 10b the TFT 55a is to the right of the p-type TFT 56b in the circuit diagram form. This is to provide the correct connection of the power supply voltages V1 and V2 (supplied by conductor columns 16a and 16b respectively) to the inverter circuits formed by TFTs 55 and 56 in the respective pixels. Thus it can be seen that the pixel interconnect line 66 connects, firstly, the sources of p-type TFTs of adjacent pixels to each other (e.g. the sources of p-type TFTs 56a and 56b), and secondly, the sources of n-type TFTs of adjacent pixels to each other (e.g. the sources of TFTs 55b and 55c).

It can be seen from FIG. 4 that the source of the TFT 57b of the pixel 10b, is connected, by virtue of its connection to the pixel interconnect line 66, to the source of the TFT 56a of the pixel 10a. The drain of the TFT 57b of the pixel 10b is connected to the next column conductor 16b. The gate of the TFT 57b of the pixel 10b is connected to the pixel control line 32. Consequently, in operation, the TFT 57b of the pixel 10b serves to isolate the connection to the source of the TFT 56a of the pixel 10a (i.e. the other of the two power supply voltage inputs of the CMOS inverter circuit 70) of the pixel 10a when the column conductor 16b is being used to provide picture data input to the pixel 10b, but to conduct the supply voltage to the connection to the source of the TFT 56a (i.e. the other of the two power supply voltage inputs of the CMOS inverter circuit 70) when the column conductor 16b is being used to provide the power supply voltage V2. This is implemented by the switching of the gate of the TFT 57b of the pixel 10b by the control signal applied to the pixel control line 32.

In other words, the use of TFT 57 is duplicated or shared between two pixels, such that the isolation function for one of the power supply voltages in a given pixel (e.g. the pixel 10 shown in FIG. 3) is performed by the isolation TFT 57 of that given pixel, whereas the isolation function for the other of the power supply voltages in a given pixel 10 is performed by the isolation TFT 57 of the pixel adjoining the given pixel. This duplicate or shared use of a given TFT 57 to isolate the power supply to respective parts of two adjoining pixels means that only one extra TFT per pixel is required compared to an equivalent pixel circuit using separate power supply lines for the CMOS inverter. Also, this means that each TFT 57 can be located beneath a corresponding column conductor 16a or 16b, thus reducing or avoiding any effect of loss of pixel aperture.

For completeness, it is noted that the connection between the drain of the TFT 57b of the pixel 10b and the column conductor 16b forms, or effectively corresponds to, the second power supply voltage input 44 described earlier with reference to FIG. 2.

Referring again to FIG. 4, another detail is that for the end pixel in a row, let us say pixel 10c, an extra TFT 57d is provided in addition to the isolation TFT 57c of the pixel 10c, since of course the absence of a further pixel to the right of pixel 10c means there is otherwise no further isolation TFT to be made use of.

The operation of the above described liquid crystal display panel 25 will now be described in more detail with reference to FIG. 5. FIG. 5 illustrates qualitatively various waveforms and signals applied in the operation of the panel 25.

FIG. 5 shows the following waveforms or signals: a power switch signal 122 applied to the power switch control line 22; a data switch 124 signal applied to the data switch control line 14; a control signal 132 applied to the pixel control line 32; and a representation 116 (shown in the way commonly used in the art for timing signals for digital lines) of whether a power supply voltage V1/V2 (this is V1 in the case of the first set of alternate column conductors 16a, and V2 in the case of the other set of alternate column conductors 16b) or a data signal is consequently applied to the column conductors 16.

Operation of the panel 25 is divided into a repeating cycle of two sets of alternating (or otherwise interspersed) time periods, comprising first time periods 130 (hereinafter referred to as power time periods 130) when the power supply voltage V1/V2 is applied to the column conductors 16, and second time periods 140 (hereinafter referred to as data time periods 140) when the data signal is applied to the column conductors 16.

The power switch signal 122 is high during the power time periods 130, and low during the data time periods 140. Opposite to this, the data switch signal 124 is low during the power time periods 130, and high during the data time periods 140.

Like the power switch signal 122, the control signal 132 is high during the power time periods 130, and low during the data time periods 140.

The operation of the pixels 10 in response to these signals will now be described with reference again to the pixel 10 shown in FIG. 3.

In the power time periods 130 the pixel 10 operates as follows. The power supply voltage V1 is supplied to column conductor 16a. The power supply voltage V2 is supplied to column conductor 16b. The pixel control signal 132 is high, consequently the gates of the TFT 57 and the TFT 53 are switched on, whereas the gate of the p-type TFT 52 is switched off. By virtue of the gate of the p-type TFT 52 being switched off, the power supply voltage V1 is isolated from the transistor route to the pixel electrode 18, reducing or avoiding erroneous effects thereon.

By virtue of the gate of the TFT 57 being turned on, the power supply voltage V1 is applied to the source of the TFT 55, i.e. provides, as required, a power supply voltage V1 (VSS) to a first power supply point of the CMOS inverter circuit 70. Due to the pixel control signal 132 being high, the gate of the TFT 57 of the next pixel (i.e. pixel 10b in terms of FIG. 4) is also switched on. By virtue of the gate of the TFT 57 of the next pixel 10b being turned on, the power supply voltage V2 is applied to the source of the TFT 56 of the present pixel (i.e. pixel 10a in terms of FIG. 4), i.e. provides, as required, a power supply voltage V2 (VDD) to the second power supply point of the CMOS inverter circuit 70.

Another process that takes place during the power time periods 130 is that, since the TFT 53 is switched on by the control signal 132 on the pixel control line 32 being high, the output from the refresh circuit, i.e. an inverted version of the picture data signal, is applied from the drains of the TFT 55 and the p-type TFT 56 (i.e. the output of the CMOS inverter circuit 70) via the TFT 53 to the pixel electrode 18. In most applications the output of the refresh circuit is not connected to the pixel electrode for the whole time that the control line 32 is at a high level. Instead, TFT 12 is turned on for a short period in order to charge the pixel electrode and then it is turned off again while control line 32 is still high.

One advantage of the pixel circuit design of this embodiment is that a common control signal 132 applied to a common pixel control line 32 serves to simultaneously provide a timing control contribution to implementation of both i) use of the column conductors 16 for supplying power supply voltages rather than picture data voltage and ii) implementing output from a refresh circuit functioning broadly speaking as described in WO 03/007286. In other words, the control signal 132/pixel control line 32 may be used to serve a dual purpose of indicating to the pixel circuit when the column conductors are carrying the power supply voltages as well as contributing to switching the pixel from a state where the pixel electrode receives picture data from the column electrodes to a state where the pixel electrode receives inverted refresh picture data from the output of the CMOS inverter circuit 70. Comparing with corresponding prior art refresh circuits powered by separate power supply lines, such as those described in WO 03/007286, it is noted that such a control signal would still be needed by the refresh circuitry, and hence the use of the control line/signal in this embodiment to indicate power supply application is advantageously achieved without the need for an additional line/signal.

In the data time periods 140 the pixel 10 operates as follows. Picture data 117 is supplied to column conductor 16a. The pixel control signal 132 is low, consequently the gates of the TFT 57 and the TFT 53 are switched off, whereas the gate of the p-type TFT 52 is switched on. By virtue of the gate of the TFT 57 being switched off, the power supply connections of the CMOS inverter circuit 70 are isolated from the column conductors 16, so that the presence of the CMOS inverter circuit 70 does not affect the operation of the panel when data is being supplied on the column conductors 16. By virtue of the gate of the TFT 53 being switched off, any output from the CMOS inverter circuit 70 is isolated from the pixel electrode 18. By virtue of the gate of the p-type TFT 52 being switched on, the picture data signal 117 is conducted to the source of the pixel select TFT 12. Thus, when the gate of the pixel select TFT 12 is switched on by a select signal applied to the row conductor 14, the picture data signal 117 is conducted via the pixel select TFT 12 to the pixel electrode 18.

In the above described embodiment, a given column conductor is allocated one of the two power supply voltages, i.e. either V1 or V2, or in other words, each column conductor 16a of the first set of alternate column conductors is allocated V1, whereas each column conductor 16b of the second set of alternate column conductors is allocated V2. However, when the present invention is applied to liquid crystal displays, it may be desirable to periodically alternate the power supply voltages applied to a particular column conductor. For example in successive periods when the power supply voltage is applied to a given column conductor 16 (i.e. 16a or 16b) it may be desirable that the voltage is alternated between V1 and V2. The advantage of this is that the mean column voltage during the power time periods 130 will then be similar to the mean column voltage during the data time periods 140. This is less likely to result in artefacts in the displayed images as a result of possible crosstalk effects arising from electric fields around the column conductors 16. This is implemented in a second embodiment, which is the same as the above described first embodiment, except for the differences described below with reference to FIG. 6.

FIG. 6 is a circuit diagram showing a three by three portion of the pixel array of the pixels of the second embodiment. Where convenient certain items have been identified with the same reference numerals as in the earlier Figures, however due to the large amount of detail, for clarity the majority of the components explained with reference to FIGS. 3 and 4 have not been identified by reference numerals as such although they can be clearly understood as they are drawn in the same form.

The array of the second embodiment has been changed (compared to the first embodiment) in that the power supply connections to the CMOS inverter circuit 70 are alternated as one moves down a column of pixels as well as when one moves along a row of pixels, whereas in first embodiment the power supply connections to the CMOS inverter circuit 70 are alternated as one moves along a row of pixels but not as one moves down a column of pixels.

This will now be explained in more detail with reference to FIG. 6. In FIG. 6, the three pixels in the top row are again identified as pixels 10a, 10b and 10c respectively. Furthermore, the three pixels in the middle row are identified as pixels 10d, 10e and 10f respectively. The TFT 55 of pixel 10a is again identified as TFT 55a, the p-type TFT 56 of pixel 10a is again identified as p-type TFT 56a, the TFT 55 of pixel 10b is again identified as TFT 55b, and the p-type TFT 56 of pixel 10b is again identified as TFT 56b. Furthermore, the TFT 55 of pixel 10d is identified as TFT 55d, the p-type TFT 56 of pixel 10d is identified as p-type TFT 56d, the TFT 55 of pixel 10e is identified as TFT 55e, and the p-type TFT 56 of pixel 10e is identified as p-type TFT 56e.

As in the first embodiment, in adjoining pixels, the TFT 55 and the p-type TFT 56 are transposed i.e. in pixel 10a the TFT 55a is to the left of the p-type TFT 56a as shown in the circuit diagram form of FIGS. 3, 4 and 6, whereas in pixel 10b the TFT 55b is to the right of the p-type TFT 56b in the circuit diagram form. Likewise, in pixel 10d the TFT 55d is to the right of the p-type TFT 56d as shown in the circuit diagram form of FIGS. 3, 4 and 6, whereas in pixel 10e the TFT 55e is to the left of the p-type TFT 56e in the circuit diagram form (i.e. in both rows the power supply connections to the CMOS inverter circuit 70 are alternated as one moves along a row of pixels).

However, in this second embodiment, the arrangement of the TFTs 55 relative to the p-type TFTs 56 is made such that in adjoining pixels in the columnar direction, the TFT 55 and the p-type TFT 56 are transposed, i.e. the power supply connections to the CMOS inverter circuit 70 are alternated as one moves down a column of pixels in addition to being alternated as one moves along a row of pixels. For example, considering the first column of pixels in FIG. 6, in pixel 10a the TFT 55a is to the left of the p-type TFT 56a as shown in the circuit diagram form of FIGS. 3, 4 and 6, whereas in pixel 10d the TFT 55d is to the right of the p-type TFT 56d as shown in the circuit diagram form of FIGS. 3, 4 and 6. And likewise, for example, considering the second column of pixels in FIG. 6, in pixel 10b the TFT 55b is to the right of the p-type TFT 56b in the circuit diagram form, whereas in pixel 10e the TFT 55e is to the left of the p-type TFT 56e in the circuit diagram form.

With this second embodiment arrangement, the control signal for a particular row of pixels is only taken to a high level when the power supply voltages on the column electrodes are appropriate (i.e. V1 rather than V2, or vice-versa) for that particular row of pixels.

In the above embodiments, use of TFT 57 is duplicated or shared between two pixels, making use of the pixel interconnect line 66. However, in other embodiments, the pixel interconnect line is eliminated, and instead a second isolation TFT is provided in each pixel. FIG. 7 shows a pixel 10 of such an embodiment, where like items with earlier Figures are represented by the same reference numerals. The pixel 10 comprises the earlier described isolation TFT 57 plus a further isolation TFT 58.

In the above embodiments, the gates of the TFT 57, p-type TFT 52 and TFT 53 are all connected to the pixel control line, and by virtue of the p-type TFT 52 being p-type and the other two TFTs being n-type, when the control signal is high the n-type TFTs 53, 57 are turned on and when the control signal is low the p-type TFT is turned on. In other embodiments, the TFT types may be reversed, i.e. TFT 52 is made n-type, and TFTs 53, 57 are made p-type, and then an opposing sense control signal is used, i.e. when the TFTs 53, 57 are to be turned on the control signal is set low, and when the TFT 52 is to be turned on, the control signal is set high.

In the above embodiments, particular refresh circuitry, including a particular CMOS inverter circuit 70 is used. However, in other embodiments, other refresh circuits, including any of those described in WO 03/007286, or other circuits working along similar lines to those, or indeed any suitable refresh circuits may be used instead. Indeed, in other embodiments, in-pixel circuitry other than refresh circuitry may be included instead or in addition to any such refresh circuitry, with the conducting columns being used to provide both power supply voltages for such circuitry and picture data input for the pixel in a time-multiplexed manner. This other circuitry may be CMOS, NMOS, PMOS or any other appropriate technology.

In each of the above embodiments, the active matrix array device is a display device comprising an array of pixels, more particularly a liquid crystal display device. However, any other suitable display types may be implemented in other embodiments, for example active matrix electroluminescent display devices.

Furthermore, other embodiments include active matrix array devices other than displays, for example active matrix sensors, or combined displays/sensors. In the case of sensor arrays, the column conductors are used, in a time-multiplexed manner, to both output sensor data from a sensor element and to provide power supply voltages for circuitry associated with the sensor element.

1. An active matrix array, comprising:
an array of matrix elements (1)arranged in rows and columns, each matrix element comprising a circuit;
a plurality of column conductors, each arranged for inputting data signals to, or outputting data signals from, the matrix elements of a respective column in first time periods and
means for providing power supply voltages for the circuit to the matrix element via the column conductors in first time periods interspersed between the first time periods.

2. An active matrix array according to claim 1, wherein the means for providing power supply voltages for the circuit to the matrix element via the column conductors comprises, in each matrix element, differentiating means for operating differently according to whether the column conductors are being supplied with the power supply voltages or whether the column conductors are being supplied with the data signals.

3. An active matrix array according to claim 1, wherein the array further comprises means for receiving a control signal to the matrix elements, the control signal being such as to indicate to the matrix elements when the column conductors rare being supplied with the power supply voltages and when the column conductors are being supplied with the data signals; and wherein the differentiating means in each matrix element comprise means for operating differently in response to the control signal.

4. An active matrix array according to claim 1, wherein the matrix elements are pixels for a display device; and each pixel comprises, in addition to a respective one of the circuits, a pixel electrode and a pixel select switching means coupled to the pixel electrode.

5. An active matrix array according to claim 4, wherein the circuit is a refresh circuit for refreshing the pixel electrode.

6. An active matrix array according to claim 3, wherein the pixels are adapted such that the control signal is used to indicate to the pixel when the column conductors are carrying the power supply voltages and to switch the pixel from a state where the pixel electrode receives picture data from the column conductors to a state where the pixel electrode receives inverted refresh picture data from the refresh circuit.

7. An active matrix array according to claim 1, wherein the circuit comprises a CMOS inverter.

8. An active matrix array of claim 3 wherein the means for receiving a control signal is coupled to the gate of a first control thin film transistor, TFT arranged to allow picture data to be provided to the pixel electrode only when the control signal is set such as to turn the first control TFT on.

9. An active matrix array according to claim 8, wherein the means for receiving a control signal is coupled to the gate of a second control TFT arranged to allow refresh data to be provided from the refresh circuit to the pixel electrode only when the control signal is set such as to turn the second control TFT on and the first control TFT off.

10. An active matrix array according to claim 9, wherein the means for receiving a control signal is coupled to the gate of a third control TFT arranged to allow the power supply voltages to be supplied to the refresh circuit only when the control signal is set such as to turn the second and third control TFTs on and the first control TFT off.

11. An active matrix array according to claim 1, wherein a first power supply voltage level is supplied to the circuits of a first column of matrix elements via a first column conductor arranged to also input or output data signals to or from the first column of matrix elements, and a second power supply voltage level is supplied to the circuits of the first column of matrix elements via a second column conductor arranged to also input or output data signals to or from a second column of matrix elements.

12. A method of operating an active matrix array device comprising an array of matrix elements arranged in rows and columns, wherein each matrix element comprises a circuit requiring power supply voltages to be supplied to the circuit, the method comprising:
in first time periods inputting a data signal to, or outputting a data signal from, the matrix element via column conductors and
in first time periods interspersed with the first time periods providing the power supply voltages to the circuit via the column conductors.
